(19) United States
(12) Patent Application Publication
(10) Pub. No.: US 2024/0396134 A1
(43) Pub. Date: Nov. 28, 2024

(54) SECONDARY BATTERY

(71) Applicant: MURATA MANUFACTURING CO., LTD., Kyoto (JP)

(72) Inventors: Ippei WAKI, Kyoto (JP); Ami ONUMA, Kyoto (JP); Hidekazu MURAKAMI, Kyoto (JP); Yosuke KONO, Kyoto (JP); Kazuhito HATTA, Kyoto (JP)

(21) Appl. No.: 18/790,289

(22) Filed: Jul. 31, 2024

Related U.S. Application Data
(63) Continuation of application No. PCT/JP2023/007910, filed on Mar. 2, 2023.

(30) Foreign Application Priority Data
Mar. 16, 2022 (JP) 2022-041855

(51) Int. Cl. H01M 50/186; H01M 50/103; H01M 50/119

(52) U.S. Cl. CPC H01M 50/186; H01M 50/103; H01M 50/119

(57) ABSTRACT

A secondary battery is provided and includes an exterior body having a first exterior portion having an accommodation portion having an accommodation space for accommodating a laminated body and a flange portion around the accommodation portion, and a second exterior portion that covers the accommodation space and to which the flange portion is joined, each of the first exterior portion and the second exterior portion has a laminated structure including a metal layer and a resin layer, a joint portion of the first exterior portion and the second exterior portion includes a first resin portion in which a resin layer of the flange portion and the resin layer of the second exterior portion are joined, a second resin portion having a projecting portion projecting from the first resin portion to the accommodation space, a sectional shape of the exterior body has a recessed portion having a bottom at a connection point between an inner surface of a resin layer of the accommodation portion and a surface of the projecting portion, and at least a part of a surface of the projecting portion forming the recessed portion is on the side opposite to the second exterior portion across a virtual line passing through the connection point and parallel to an inner surface of the metal layer of the second exterior portion.

### CROSS REFERENCE TO RELATED APPLICATIONS

The present application is a continuation of PCT patent application no. PCT/JP2023/007910, filed on Mar. 2, 2023, which claims priority to Japanese patent application no. 2022-041855, filed on Mar. 16, 2022, the entire contents of which are herein incorporated by reference.

### BACKGROUND

The present disclosure relates to a secondary battery.

A film exterior battery is disclosed and including a power generating element and a film-shaped exterior material that accommodates the power generating element. The film-shaped exterior material has a sealing portion sealed around the power generating element.

### SUMMARY

The present disclosure relates to a secondary battery.

The power generating element may generate gas by repeated charging and discharging or use in a high-temperature environment. When pressure of gas increases in the film-shaped exterior material, the power generating element may be deformed. When the power generating element is deformed, safety of the battery is decreased.

The present disclosure relates, in an embodiment, has to prevent decrease in safety due to deformation of a power generating element in a secondary battery in which a laminated body is accommodated in an exterior body.

A secondary battery of the present disclosure includes a laminated body including a plurality of positive electrodes and a plurality of negative electrodes, the positive electrodes and the negative electrodes being alternately laminated with a separator interposed therebetween, and an exterior body including a first exterior portion including an accommodation portion of a recessed shape having an accommodation space for accommodating the laminated body on an inner side and a flange portion around a peripheral edge portion of the accommodation portion, and a second exterior portion covering the accommodation space and having a flat plate shape to which the flange portion is joined. A peripheral edge of the exterior body has a shape having one side in plan view when the exterior body is viewed along a thickness direction of the flange portion, each of the first exterior portion and the second exterior portion has a laminated structure including a metal layer and a resin layer, the resin layer of the first exterior portion and the resin layer of the second exterior portion face each other, a joint portion of the first exterior portion and the second exterior portion includes a first resin portion where a resin layer of the flange portion and the resin layer of the second exterior portion are joined, and a second resin portion having a projecting portion projecting from the first resin portion toward the accommodation space, a sectional shape when the exterior body is cut at a central portion of the side by a plane which intersects the side and is along the thickness direction of the flange portion includes a recessed portion which is formed by an inner surface of a resin layer of the accommodation portion and a surface of the projecting portion and has a bottom at a connection point between the inner surface of the resin layer of the accommodation portion and the surface of the projecting portion, and in the sectional shape, the connection point is a point at which, when a virtual line parallel to an inner surface of the metal layer of the second exterior portion is moved from the inner surface of the metal layer of the second exterior portion to the accommodation space side along a direction orthogonal to the virtual line, the virtual line and the inner surface of the resin layer of the accommodation portion first come into contact with each other, and at least a part of a surface of the projecting portion forming the recessed portion is on a side opposite to the second exterior portion across the virtual line passing through the connection point.

According to the secondary battery of the present disclosure, it is possible to suppress decrease in safety according to an embodiment.

### BRIEF DESCRIPTION OF THE FIGURES

FIG. 1 is a plan view illustrating an outline of a secondary battery according to an embodiment.

FIG. 2 is an exploded perspective view illustrating a configuration of the secondary battery according to an embodiment.

FIG. 3 is a sectional view of the secondary battery taken along line III-III of FIG. 1.

FIG. 4 is an enlarged sectional view around a recessed portion illustrated in FIG. 3.

FIG. 5 is a sectional view of the secondary battery illustrating a joining step of a flange portion and a second exterior portion.

FIG. 6 is a sectional view of the secondary battery of a second example.

FIG. 7 is a sectional view of the secondary battery of a third example.

FIG. 8 is a sectional view of a secondary battery of a first comparative example.

FIG. 9 is a sectional view of a secondary battery of a second comparative example.

FIG. 10 is a sectional view of a secondary battery of a third comparative example.

FIG. 11 is an exploded perspective view illustrating the secondary battery according to a variation of an embodiment.

### DETAILED DESCRIPTION

The present technology will be described below in further detail including with reference to the drawings according to an embodiment. Note that the present disclosure is not limited thereto. Each embodiment is illustrative, and it goes without saying that replacement and combination of a part of configurations shown in different embodiments can be performed.

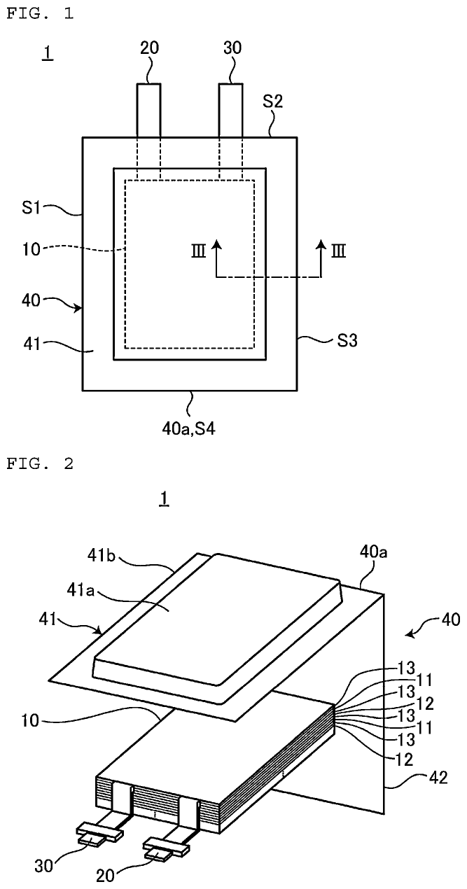

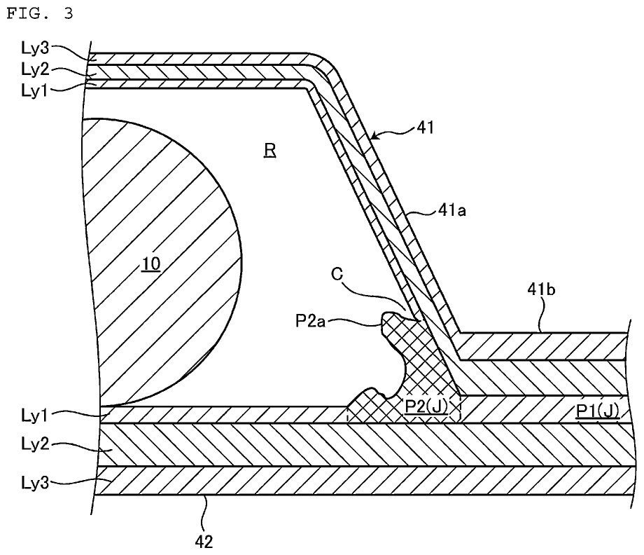

FIG. 1 is a plan view illustrating an outline of a secondary battery according to an embodiment. FIG. 2 is an exploded perspective view illustrating a configuration of the secondary battery according to an embodiment. FIG. 3 is a sectional view of the secondary battery taken along line III-III of FIG. 1. The line III-III is a line which intersects a side S3 of an exterior body 40, in which a first exterior portion 41 and the second exterior portion 42 described later are joined, at a central portion of the side S3. Further, the line III-III is a line indicating a plane along a thickness direction of a flange portion 41b of the exterior body 40 described later. That is, FIG. 3 is a diagram illustrating a sectional shape when the exterior body 40 is cut at a central portion of the side S3 by a plane along the thickness direction of the flange portion 41b.

A secondary battery 1 is, for example, a lithium ion battery. The secondary battery 1 includes a laminated body 10, a positive electrode terminal 20, a negative electrode terminal 30, and the exterior body 40.

The laminated body 10 has a plurality of sheet-like positive electrodes 11 and negative electrodes 12, and the positive electrodes 11 and the negative electrodes 12 are alternately laminated with a separator 13 interposed between them (see FIG. 2). The laminated body 10 has a rectangular shape in plan view. Note that, in the present description, “plan view” means that the secondary battery 1 (exterior body 40) is viewed along a thickness direction of the flange portion 41b described later.

The positive electrode terminal 20 is electrically connected to a plurality of the positive electrodes 11. A part of the positive electrode terminal 20 is located outside the exterior body 40. The negative electrode terminal 30 is electrically connected to a plurality of the negative electrodes 12. A part of the negative electrode terminal 30 is located outside the exterior body 40.

The exterior body 40 has a rectangular shape in plan view. Specifically, a peripheral edge of the exterior body 40 has a rectangular shape in plan view, and has four sides S1, S2, S3, and S4 (see FIG. 1). Note that it is needless to say that the exterior body 40 is not limited to a rectangular shape in plan view, and a peripheral edge of the exterior body 40 may have a shape having at least one side in plan view.

Further, as illustrated in FIG. 2, the exterior body 40 has a shape in which one film is bent at a bent portion 40a. The exterior body 40 has the first exterior portion 41 and the second exterior portion 42 which are folded back at the bent portion 40a and overlap each other. The first exterior portion 41 and the second exterior portion 42 are continuous at the bent portion 40a. The bent portion 40a is located on the side S4.

The first exterior portion 41 includes an accommodation portion 41a and the flange portion 41b (see FIGS. 2 and 3).

The accommodation portion 41a has, on the inner side, a recessed shape having an accommodation space R for accommodating the laminated body 10. The accommodation space R has size capable of accommodating the entire laminated body 10. The accommodation portion 41a is formed by, for example, pressing a central portion of the first exterior portion 41. Further, the accommodation portion 41a accommodates an electrolyte (for example, nonaqueous electrolytic solution).

The flange portion 41b is located around a peripheral edge portion of the accommodation portion 41a and has a flat plate shape. The flange portion 41b is not pressed. Therefore, thickness of the accommodation portion 41a that is pressed is less than thickness of the flange portion 41b.

The second exterior portion 42 has a flat plate shape which covers the accommodation space R and to which the flange portion 41b is joined. The second exterior portion 42 is not pressed. Therefore, thickness of the accommodation portion 41a that is pressed is less than thickness of the second exterior portion 42.

The flange portion 41b of the first exterior portion 41 and the second exterior portion 42 are joined at a portion other than the bent portion 40a around the accommodation portion 41a. Specifically, as illustrated in FIG. 1, three of the sides S1, S2, and S3 other than one of the side S4 on which the bent portion 40a is formed are joined. By the above, the first exterior portion 41 and the second exterior portion 42 are sealed, and leakage of an electrolyte is prevented.

Note that the exterior body 40 may be formed of two films. In this case, one of the two films is the first exterior portion 41, and the other is the second exterior portion 42. Further, in this case, the exterior body 40 does not have the bent portion 40a, and the flange portion 41b of the first exterior portion 41 and the second exterior portion 42 are joined to each other over the entire periphery of the accommodation portion 41a (that is, in each of four of the sides S1, S2, S3, and S4). In the present embodiment, the exterior body 40 is formed of one film, and the number of components and joined parts can be reduced as compared with a case where the exterior body 40 is formed of two films. Therefore, reduction in cost of the secondary battery 1 can be achieved.

As illustrated in FIG. 3, each of the first exterior portion 41 and the second exterior portion 42 has a laminated structure including a resin layer Ly1 and a metal layer Ly2. That is, the film constituting the exterior body 40 has a laminated structure including the resin layer Ly1 and the metal layer Ly2. Specifically, in each of the first exterior portion 41 and the second exterior portion 42, the resin layer Ly1, the metal layer Ly2, and a protective layer Ly3 are laminated in this order.

The resin layer Ly1 is formed of thermoplastic resin such as polypropylene. The exterior body 40 is bent such that the resin layer Ly1 is on the inner side.

The metal layer Ly2 is a layer that prevents permeation of gas, and is formed of, for example, aluminum foil. The protective layer Ly3 is a layer that protects the exterior body 40, and is formed of, for example, resin such as nylon and polyethylene terephthalate. The metal layer Ly2 of the first exterior portion 41 and the metal layer Ly2 of the second exterior portion 42 are formed by folding one metal layer included in one film as described above.

The exterior body 40 is bent such that the resin layer Ly1 of the first exterior portion 41 and the resin layer Ly1 of the second exterior portion 42 face each other. That is, the resin layer Ly1 of the first exterior portion 41 and the resin layer Ly1 of the second exterior portion 42 face each other. The resin layer Ly1 of the flange portion 41b and the resin layer Ly1 of the second exterior portion 42 are thermally welded to form a joint portion J where the first exterior portion 41 and the second exterior portion 42 are joined.

The joint portion J is provided along the sides S1, S2, and S3 of the exterior body 40 where the flange portion 41b and the second exterior portion 42 are joined. The joint portion J includes a first resin portion P1 and a second resin portion P2.

The first resin portion P1 is a portion where the resin layer Ly1 of the flange portion 41b and the resin layer Ly1 of the second exterior portion 42 are joined. That is, the first resin portion P1 is located between the metal layer Ly2 of the flange portion 41b and the metal layer Ly2 of the second exterior portion 42.

The second resin portion P2 is a portion where resin is continuous with the first resin portion P1 and fills a space between a part of the accommodation portion 41a and the second exterior portion 42 in the accommodation space R. Specifically, the second resin portion P2 is a resin lump continuous with the first resin portion P1, the resin layer Ly1 of the accommodation portion 41a, and the resin layer Ly1 of the second exterior portion 42, and is a bead formed when the flange portion 41b and the second exterior portion 42 are welded (details will be described later). The second resin portion P2 has a projecting portion P2a projecting from the first resin portion P1 toward the accommodation space R.

The projecting portion P2a is a protruding portion in which a part of the second resin portion P2 projects. Further, the secondary battery 1 has a recessed portion C between an inner surface of the accommodation portion 41a and the second resin portion P2. The recessed portion C may have a groove shape or a hole shape. The recessed portion C is arranged in the vicinity of a central portion of the sides S1, S2, and S3 of the exterior body 40. That is, when a central portion of the sides S1, S2, and S3 where the flange portion 41b and the second exterior portion 42 are joined is cut along a thickness direction of the flange portion 41b, the recessed portion C appears on the inner side of the exterior body 40. Note that the recessed portion C may be in the vicinity of a portion other than a central portion of the sides S1, S2, and S3.

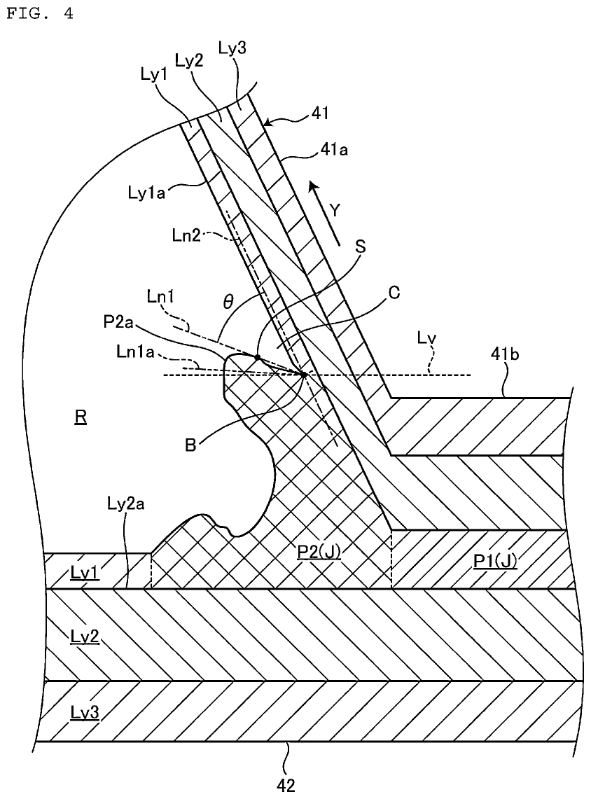

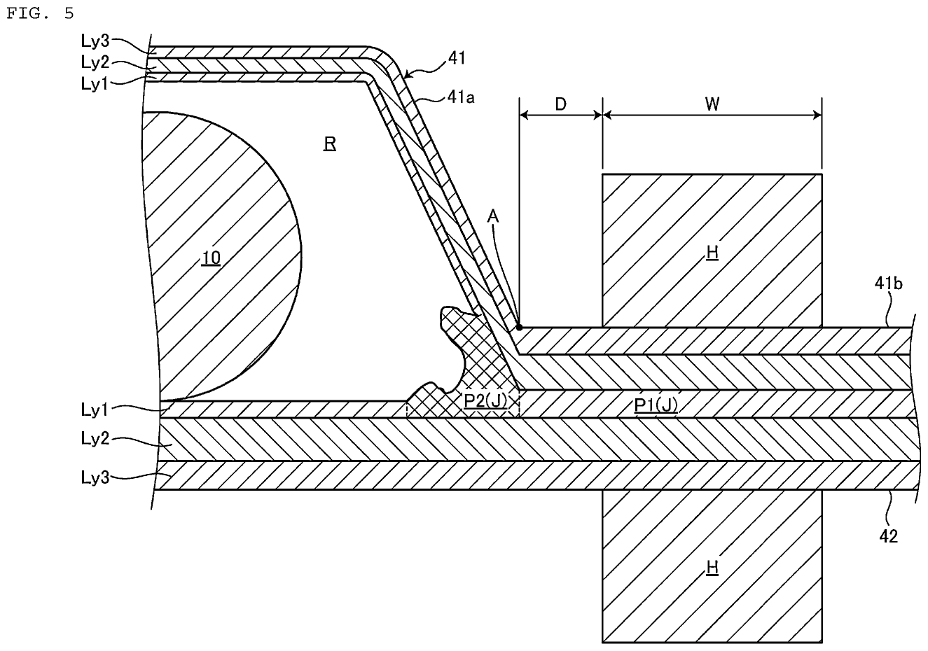

FIG. 4 is an enlarged sectional view around a recessed portion illustrated in FIG. 3. That is, FIG. 4 is an enlarged diagram of a sectional shape when the exterior body 40 is cut at a central portion of the side S3 by a plane which intersects the side S3 and is along a thickness direction of the flange portion 41b. In the sectional shape illustrated in FIG. 4, the recessed portion C is formed by an inner surface Ly1a of the resin layer Ly1 of the accommodation portion 41a along a first direction Y in which the metal layer Ly2 of the accommodation portion 41a extends and a surface of the projecting portion P2a. The first direction Y is a direction in which the metal layer Ly2 of the accommodation portion 41a extends from an end of the accommodation portion 41a connected to the flange portion 41b in sectional view.

Further, in the sectional shape of FIG. 4, the bottom of the recessed portion C is a connection point B between the inner surface Ly1a of the resin layer Ly1 of the accommodation portion 41a and a surface of the projecting portion P2a. The connection point B is a point at which, when a virtual line Lv parallel to an inner surface Ly2a of the metal layer Ly2 of the second exterior portion 42 is moved from the inner surface Ly2a of the metal layer Ly2 of the second exterior portion 42 to the accommodation space R side along a direction orthogonal to the virtual line Lv, the virtual line Lv and the inner surface Ly1a of the resin layer Ly1 of the accommodation portion 41a are first in contact with each other. The virtual line Lv illustrated in FIG. 4 indicates a state in which the virtual line Lv is moved from the inner surface Ly2a of the metal layer Ly2 of the second exterior portion 42 and first comes into contact with the inner surface Ly1a of the resin layer Ly1 of the accommodation portion 41a, and indicates a state passing through the connection point B.

Further, in the sectional shape of FIG. 4, at least a part of a surface of the projecting portion P2a forming the recessed portion C is on the opposite side to the second exterior portion 42 across the virtual line Lv passing through the connection point B. By the above, an angle θ formed by a tangent line Ln1 passing through the connection point B and in contact with a surface of the projecting portion P2a and a parallel line Ln2 parallel to the first direction Y becomes an acute angle.

Specifically, in the sectional shape of FIG. 4, the tangent line Ln1 is a tangent line that passes through the connection point B and is in contact with a surface of the projecting portion P2a at a point S on a surface of the projecting portion P2a. That is, a contact point of the tangent line Ln1 is the point S. Note that, in other words, the connection point B is a base end on the resin layer Ly1 side of the first exterior portion 41 in the projecting portion P2a.

As described above, the tangent line Ln1 is in contact with a surface of the projecting portion P2a at the point S different from the connection point B. Note that the connection point B and a contact point may be the same point. The tangent line Ln1a in this case is a tangent line that passes through the connection point B and is in contact with a surface of the projecting portion P2a at the connection point B. As described above, in a case where there are a plurality of tangent lines, the angle θ formed by at least one of a plurality of the tangent lines and the parallel line Ln2 only needs to be an acute angle.

Next, operation of the secondary battery 1 in a case where gas is generated from the laminated body 10 will be described. Assuming that gas is generated from the laminated body 10, pressure in the accommodation space R increases. By the above, the accommodation portion 41a and the second exterior portion 42 covering the accommodation space R are deformed, and stress is generated in the accommodation portion 41a and the second exterior portion 42.

As described above, the angle θ is an acute angle in the recessed portion C, and stress concentrates on the bottom (connection point B) of the recessed portion C. By the above, a crack is generated from the bottom (connection point B) of the recessed portion C, and the crack progresses as the pressure increases.

As described above, thickness of the accommodation portion 41a that is pressed is less than thickness of the second exterior portion 42. That is, thickness of the resin layer Ly1 of the accommodation portion 41a along the first direction Y is less than thickness of the resin layer Ly1 of the second exterior portion 42 other than the joint portion J. Further, thickness of the metal layer Ly2 of the accommodation portion 41a along the first direction Y is less than thickness of the metal layer Ly2 of the second exterior portion 42 other than the joint portion J. By the above, the accommodation portion 41a along the first direction Y is more easily deformed than the second exterior portion 42 other than the joint portion J. Therefore, a crack generated from the bottom of the recessed portion C progresses toward the metal layer Ly2 of the accommodation portion 41a.

When the crack reaches a boundary between the resin layer Ly1 and the metal layer Ly2 of the accommodation portion 41a, the resin layer Ly1 and the metal layer Ly2 of the accommodation portion 41a are peeled. Furthermore, as pressure increases, the resin layer Ly1 and the metal layer Ly2 of the flange portion 41b are peeled, and the exterior body 40 is cleaved.

When the exterior body 40 is cleaved, gas leaks from the accommodation space R to the outside, and increase in pressure in the accommodation space R is suppressed. Therefore, deformation of the laminated body 10 can be prevented, and decrease in safety of the secondary battery 1 can be prevented.

Further, as described above, the accommodation portion 41a along the first direction Y is more easily deformed than the second exterior portion 42 other than the joint portion J. Therefore, a deformation amount of the accommodation portion 41a due to pressure of the accommodation space R is larger than a deformation amount of the second exterior portion 42 other than the joint portion J. Therefore, as compared with a case where thickness of the accommodation portion 41a is equal to thickness of the second exterior portion 42, stress at the bottom of the recessed portion C is large, and the exterior body 40 is easily cleaved. Therefore, it is possible to further prevent decrease in safety of the secondary battery 1.

Further, in a case where pressure in the accommodation space R increases, in the accommodation portion 41a along the first direction Y, a deformation amount in the vicinity of a central portion of the sides S1, S2, and S3 where the flange portion 41b and the second exterior portion 42 are joined is larger than a deformation amount in the vicinity of both end portions of the sides S1, S2, and S3. That is, stress in the recessed portion C in the vicinity of a central portion of the sides S1, S2, and S3 where the flange portion 41b and the second exterior portion 42 are joined is larger than stress in the recessed portion C in the vicinity of both end portions of the sides S1, S2, and S3. Therefore, in a case where the recessed portion C is present in the vicinity of the central portion of the sides S1, S2, and S3 where the flange portion 41b and the second exterior portion 42 are joined, the exterior body 40 is cleaved more easily, and it is possible to further prevent decrease in safety of the secondary battery 1.

The first exterior portion 41 and the second exterior portion 42 are continuous at the bent portion 40a, and the side S4 having the bent portion 40a does not have the joint portion J. That is, in a case where the exterior body 40 has the bent portion 40a, the exterior body 40 is formed of two films, and the number of sides having the joint portion J is small as compared with a case where the exterior body 40 does not have the bent portion 40a. Therefore, in a case where the exterior body 40 has the bent portion 40a, as compared with a case where the exterior body 40 does not have the bent portion 40a, magnitude of stress acting on the joint portion J and the recessed portion C is large, and the exterior body 40 is easily cleaved.

Next, a joining step of the flange portion 41b and the second exterior portion 42 will be described. The resin layer Ly1 of the flange portion 41b and the resin layer Ly1 of the second exterior portion 42 are thermally welded on three of the sides S1, S2, and S3 excluding the side S4 where the bent portion 40a is present one side at a time, so that the flange portion 41b and the second exterior portion 42 are joined. Note that the positive electrode terminal 20 and the negative electrode terminal 30 are sandwiched between the resin layer Ly1 of the flange portion 41b and the resin layer Ly1 of the second exterior portion 42, and are in close contact with melted resin.

FIG. 5 is a sectional view of the secondary battery 1 illustrating an outline of the joining step of the flange portion 41b and the second exterior portion 42. In the joining step, a pair of heating members H heated to a predetermined temperature sandwich the flange portion 41b and the second exterior portion 42 at a predetermined position. Width W of the heating member H is, for example, 6 mm. The predetermined position is determined by a distance D (for example, 0.3 to 0.4 mm) between an end A on the accommodation portion 41a side of the flange portion 41b and the heating member H.

Subsequently, a pair of the heating members H presses the flange portion 41b and the second exterior portion 42 with predetermined pressure (for example, 0.3 to 0.45 MPa), at a predetermined speed (for example, 50 mm/min), and for predetermined time (for example, 3 to 7 seconds) determined in advance. The predetermined temperature, the predetermined position, the predetermined pressure, the predetermined speed, and the predetermined time are actually measured and derived in advance by an experiment or the like so as to obtain desired joining strength at the joint portion J.

Further, the predetermined temperature and the predetermined pressure are actually measured and derived in advance by an experiment or the like so as to form the recessed portion C (details will be described later).

In the joining step, a pair of the heating members H press the flange portion 41b and the second exterior portion 42, so that the resin layers Ly1 are melted and joined between the flange portion 41b and the second exterior portion 42. In this manner, the joint portion J is formed. Further, when the joint portion J is formed, the resin melted between the flange portion 41b and the second exterior portion 42 projects into the accommodation space R. By the above, the second resin portion P2 having the projecting portion P2a and the recessed portion C are formed.

Next, a relationship between a joining condition and the presence or absence of the recessed portion C will be described with reference to three of a first example, a second example, and a third example, and three of a first comparative example, a second comparative example, and a third comparative example.

In three of the first example, the second example, and the third example and three of the first comparative example, the second comparative example, and the third comparative example, the resin layer Ly1 of the first exterior portion 41 and the second exterior portion 42 is polypropylene having thickness of 35 μm, a melting point of 140° C., and a softening point of 120° C., and has a three-layer structure in which a random polymer layer, a block polymer layer, and a random polymer layer are laminated in this order. The metal layer Ly2 is aluminum having thickness of 35 μm. The protective layer Ly3 is nylon having thickness of 15 μm.

In three of the first example, the second example, and the third example and three of the first comparative example, the second comparative example, and the third comparative example, among joining conditions, speeds at and time for which the heating member H presses the flange portion 41b and the second exterior portion 42 are equal, the speed is 50 mm/min, and the time is 3 seconds. On the other hand, temperature (hereinafter, referred to as heating temperature) of the heating member H and pressure (hereinafter, referred to as pressing force) acting on the flange portion 41b and the second exterior portion 42 are changed. Further, the number of films constituting the exterior body 40 and the presence or absence of the accommodation portion 41a in the second exterior portion 42 are changed.

TABLE 1

| | Number of | | | | | | Temperature |
|---|---|---|---|---|---|---|---|
| | films | Number of | | | Presence | Temperature | rise rate |
| | constituting | accommodation | Heating | Pressing | or absence | (° C.) of | ( ° C./min) of |
| | exterior | portions | temperature | force | of recessed | secondary | secondary |
| | body 40 | 41a | (° C.) | (MPa) | portion C | battery 1 | battery 1 |
| First | 1 | 1 | 190 | 0.3 | Present | 149 | −0.3 |
| example | | | | | | | |
| Second | 1 | 1 | 185 | 0.45 | Present | 151 | −0.1 |
| example | | | | | | | |
| Third | 2 | 1 | Flange | 0.4 | Present | 153 | +0.1 |
| example | | | 41b side: | | | | |
| | | | 200 Second | | | | |
| | | | exterior | | | | |
| | | | portion 42 | | | | |
| | | | side: 190 | | | | |
| First | 1 | 1 | 170 | 0.3 | Absent | 160 | +1.0 |
| comparative | | | | | | | |
| example | | | | | | | |
| Second | 1 | 1 | 190 | 0.2 | Absent | 158 | +1.3 |
| comparative | | | | | | | |
| example | | | | | | | |
| Third | 1 | 2 | 190 | 0.3 | Absent | 163 | +3.0 |
| comparative | | | | | | | |
| example | | | | | | | |

The first example has the same configuration as the above embodiment, and as in the above embodiment, the exterior body 40 is formed of one film, and the number of the accommodation portions 41a is one. Specifically, the first exterior portion 41 has the accommodation portion 41a, and the second exterior portion 42 does not have the accommodation portion 41a. Further, the heating temperature is 190° C., and the pressing force is 0.3 MPa. As illustrated in FIG. 3, the first example has the recessed portion C.

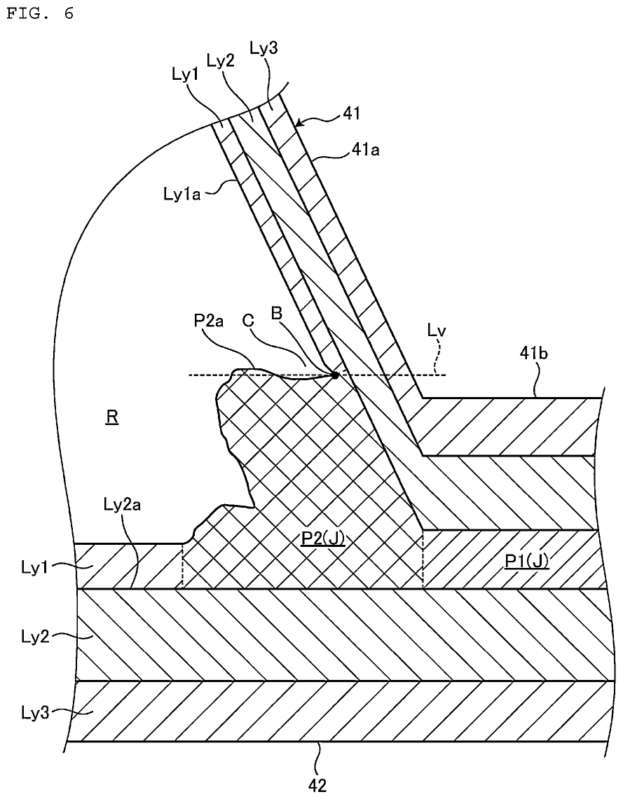

FIG. 6 is a sectional view of the secondary battery of the second example. In the second example, the exterior body 40 is formed of one film, and the number of the accommodation portions 41a is one. Further, the heating temperature is 185° C., and the pressing force is 0.45 MPa. As illustrated in FIG. 6, the second example has the recessed portion C.

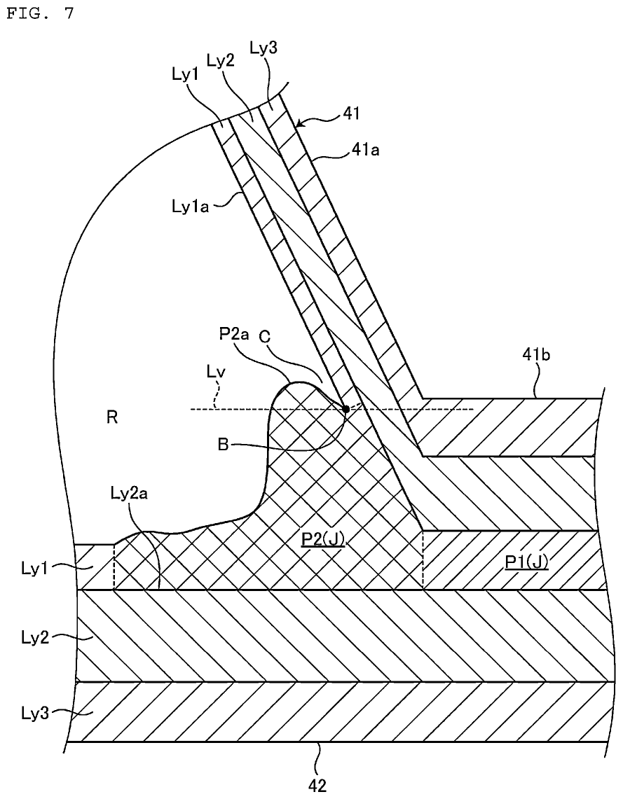

FIG. 7 is a sectional view of the secondary battery of the third example. In the third example, the exterior body 40 is formed of two films, and the number of the accommodation portions 41a is one. In a case where the exterior body 40 is formed of two films, one film constitutes the first exterior portion 41, the other film constitutes the second exterior portion 42, and the bent portion 40a is not formed.

Further, in the third example, the heating temperature of the heating member H pressing the flange portion 41b is 200° C., the heating temperature of the heating member H pressing the second exterior portion 42 is 190° C., and the pressing force is 0.4 MPa. As illustrated in FIG. 7, the third example has the recessed portion C.

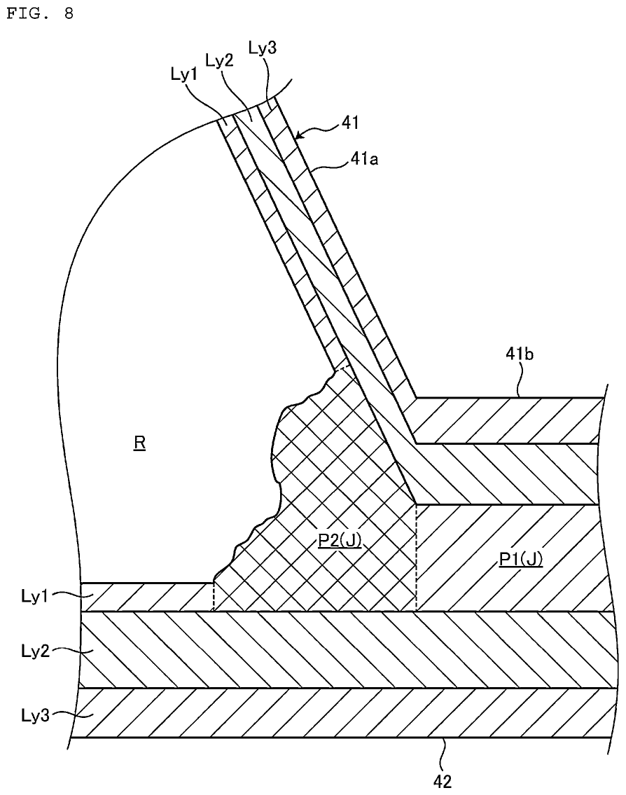

FIG. 8 is a sectional view of the secondary battery of the first comparative example. In the first comparative example, the heating temperature is lower than that in the first example, and is 170° C. In this case, resin melted in the joining step does not sufficiently project into the accommodation space R. That is, the first comparative example does not have the recessed portion C.

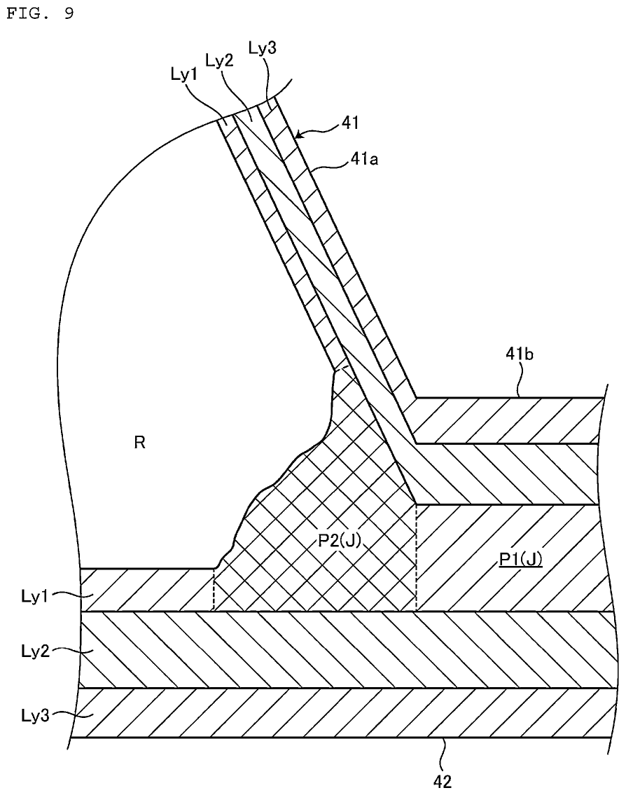

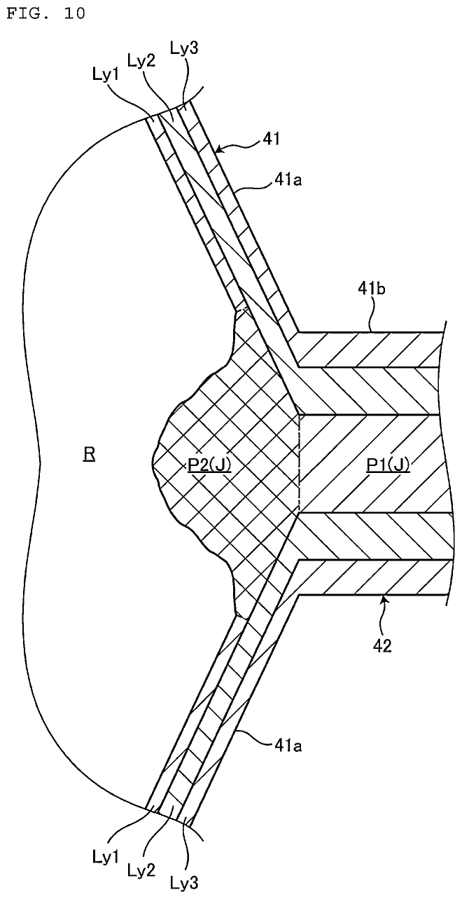

FIG. 9 is a sectional view of the secondary battery of the second comparative example. In the second comparative example, the pressing force is lower than that in the first comparative example, and is 0.2 MPa. In this case, resin melted in the joining step does not sufficiently project into the accommodation space R. That is, the second comparative example does not have the recessed portion C.

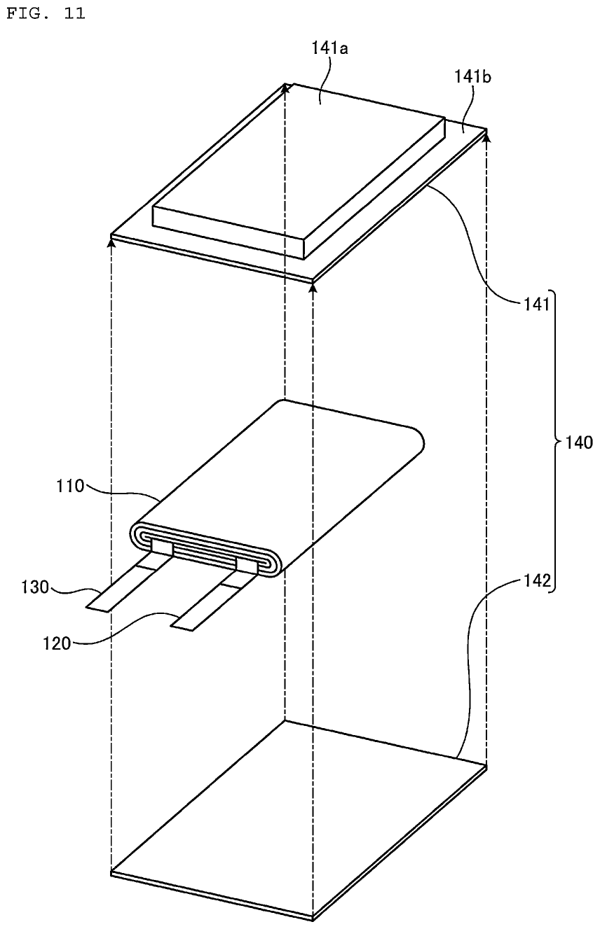

FIG. 10 is a sectional view of the secondary battery of the third comparative example. In the third comparative example, two of the accommodation portions 41a are formed. Specifically, the accommodation portion 41a is formed in each of the first exterior portion 41 and the second exterior portion 42. As illustrated in FIG. 10, in a case where the accommodation portion 41a is also provided in the second exterior portion 42, the accommodation space R is formed by the accommodation portion 41a of the first exterior portion 41 and the accommodation portion 41a of the second exterior portion 42. A height of each of the accommodation portion 41a of the first exterior portion 41 and the accommodation portion 41a of the second exterior portion 42 in a case where the second exterior portion 42 has the accommodation portion 41a is lower than a height of the accommodation portion 41a of the first exterior portion 41 in a case where the second exterior portion 42 does not have the accommodation portion 41a.

The third comparative example does not have the recessed portion C. This is because in a case where the second exterior portion 42 has the accommodation portion 41a, resin melted and projecting into the accommodation space R in the joining step does not approach an inner surface of the resin layer Ly1 of the first exterior portion 41. In other words, as in the above-described embodiment, in a case where the second exterior portion 42 does not have the accommodation portion 41a and the second exterior portion 42 has a flat plate shape, in the joining step, melted resin projects so as to approach the inner surface Ly1a of the resin layer Ly1 of the accommodation portion 41a (see FIG. 4). That is, in a case where the second exterior portion 42 does not have the accommodation portion 41a and the second exterior portion 42 has a flat plate shape, the recessed portion C is easily formed.

Further, Table 1 shows a result of an abnormally high temperature test. The abnormally high temperature test is a test in which the secondary battery 1 charged under a predetermined charging condition is accommodated in a thermostatic chamber, and temperature of the secondary battery 1 and a temperature rise rate of the secondary battery 1 when temperature in the thermostatic chamber is raised are measured.

In the predetermined charging condition, ambient temperature is 23° C., a current value is 0.2 ItA, voltage is constant at 4.25 V, and charging time is six hours. That is, in the abnormally high temperature test, the secondary battery 1 is charged by constant current-constant voltage charging.

Temperature in the thermostatic chamber is set to 23° C. at the start of the test, and raised to 130° C. by 5° C./min and maintained. Temperature of the secondary battery 1 is set to temperature of the positive electrode terminal 20 and the negative electrode terminal 30. A measurement timing of temperature of the secondary battery 1 is a time point at which 25 minutes elapses from a time point at which temperature in the thermostatic chamber reaches 130° C. A temperature rise rate of the secondary battery 1 is a temperature rise rate per unit time between a measurement timing of temperature of the secondary battery 1 and a time point one minute before the measurement timing.

In the first example, the second example, and the third example, temperature of the secondary battery 1 is lower than that in the first comparative example, the second comparative example, and the third comparative example. Further, in the first example, the second example, and the third example, a temperature rise rate is lower than that in the first comparative example, the second comparative example, and the third comparative example, and is close to zero. This result indicates that in the first example, the second example, and the third example having the recessed portion C, the exterior body 40 is cleaved, so that the accommodation space R communicates with the outside, and temperature rise of the secondary battery 1 is suppressed.

On the other hand, in the first comparative example, the second comparative example, and the third comparative example, temperature of the secondary battery 1 is higher than that in the first example, the second example, and the third example. Further, the temperature rise rate is 1.0° C./min or more, and temperature of the secondary battery 1 rises. This result shows that in the first comparative example, the second comparative example, and the third comparative example not having the recessed portion C, the exterior body 40 is not cleaved, and temperature of the secondary battery 1 continues to rise.

Note that an embodiment described above is intended to facilitate understanding of the present disclosure, but not intended to construe the present disclosure in any limited way. The present disclosure may be modified or improved without departing from the spirit of the present disclosure, and the present disclosure includes equivalents of the present disclosure.

FIG. 11 is an exploded perspective view illustrating the secondary battery according to a variation of an embodiment. As illustrated in FIG. 11, a laminated body 110 is a wound type.

The laminated body 110 of a wound type has an elongated positive electrode and an elongated negative electrode, and the positive electrode and the negative electrode are laminated with a separator interposed between them and wound. The laminated body 110 has a rectangular shape in plan view.

A positive electrode terminal 120 is electrically connected to the positive electrode. A part of the positive electrode terminal 120 is located outside an exterior body 140. A negative electrode terminal 130 is electrically connected to the negative electrode. A part of the negative electrode terminal 130 is located outside the exterior body 140.

In the laminated body 10 of a laminated type, a plurality of sheets are laminated, and if gas is generated, the gas leaks from between a plurality of the sheets, and thus leaks from the entire circumference of a side surface of the laminated body 10 of a laminated type. On the other hand, in the laminated body 110 of a wound type, a long sheet is wound as described above, and if gas is generated, the gas does not leak from the entire circumference of a side surface of the laminated body 110 of a wound type but leaks from two side surfaces facing opposite sides. That is, an area of a portion where the gas leaks, and a leakage flow rate of the gas per unit time are larger in the laminated body 10 of a laminated type than in the laminated body 110 of a wound type. Therefore, a speed at which pressure in the accommodation space R increases due to leakage of the gas is larger in the laminated body 10 of a laminated type than in the laminated body 110 of a wound type. Therefore, as to cleavage of the exterior bodies 40 and 140 due to stress concentrated on the bottom of the recessed portion C, the exterior body 40 accommodating the laminated body 10 of a laminated type is cleaved earlier than the exterior body 140 accommodating the laminated body 110 of a wound type. Therefore, it is possible to further suppress decrease in safety due to deformation of a power generating element in the exterior body 40 accommodating the laminated body 10 of a laminated type than in the exterior body 140 accommodating the laminated body 110 of a wound type.

Further, the exterior body 140 illustrated in FIG. 11 is formed of two films. In this case, one of the two films is a first exterior portion 141, and the other film is a second exterior portion 142.

Note that the laminated body may have an all-solid structure. In this case, the laminated body has an all-solid structure in which a plurality of positive electrodes and a plurality of negative electrodes are alternately laminated with a solid electrolyte interposed between them. Note that the accommodation space R may accommodate nonaqueous electrolytic solution or polymer resin impregnated with nonaqueous electrolytic solution.

Further, the accommodation portion 41a may be formed such that thicknesses of the resin layer Ly1 and the metal layer Ly2 of the first exterior portion 41 along the first direction Y is equal to thicknesses of the resin layer Ly1 and the metal layer Ly2 of the second exterior portion 42 other than the joint portion J, respectively.

Further, the secondary battery 1 may have a shape other than a rectangular shape in plan view, for example, may have a circular shape in plan view. In this case, the joint portion J may have a circular shape in plan view.

Further, although the angle θ formed by the tangent lines Ln1 and Ln1a passing through the bottom (connection point B) of the recessed portion C and in contact with a surface of the projecting portion P2a and the parallel line Ln2 parallel to the first direction Y is an acute angle, instead of the parallel line Ln2, an angle formed by the tangent lines Ln1 and Ln1a passing through the connection point B and in contact with a surface of the projecting portion P2a and a tangent line passing through the connection point B and in contact with the inner surface Ly1a of the resin layer Ly1 at the connection point B may be an acute angle.

### DESCRIPTION OF REFERENCE SYMBOLS

1: Secondary battery
10: Laminated body
40: Exterior body
40a: Bent portion
41: First exterior portion
41a: Accommodation portion
41b: Flange portion
42: Second exterior portion
B: Connection point (bottom of recessed portion)
C: Recessed portion
J: Joint portion
Ln1, Ln1a: Tangent line
Ln2: Parallel line
Ly1: Resin layer
Ly1a: Inner surface of resin layer of accommodation portion
Ly2: Metal layer
Ly2a: Inner surface of metal layer of second exterior portion
Lv: Virtual line
P1: First resin portion
P2: Second resin portion
P2a: Projecting portion
R: Accommodation space
S1, S2, S3: Side
Y: First direction
θ: Angle

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a laminated body including a plurality of positive electrodes and a plurality of negative electrodes, the positive electrodes and the negative electrodes being alternately laminated with a separator interposed therebetween; and
an exterior body including a first exterior portion including an accommodation portion of a recessed shape having an accommodation space for accommodating the laminated body on an inner side and a flange portion around a peripheral edge portion of the accommodation portion, and a second exterior portion covering the accommodation space and having a flat plate shape to which the flange portion is joined, wherein
a peripheral edge of the exterior body has a shape having one side in plan view when the exterior body is viewed along a thickness direction of the flange portion,
each of the first exterior portion and the second exterior portion has a laminated structure including a metal layer and a resin layer,
the resin layer of the first exterior portion and the resin layer of the second exterior portion face each other,
a joint portion of the first exterior portion and the second exterior portion includes a first resin portion where a resin layer of the flange portion and the resin layer of the second exterior portion are joined, and a second resin portion having a projecting portion projecting from the first resin portion toward the accommodation space,
a sectional shape when the exterior body is cut at a central portion of the side by a plane which intersects the side and is along the thickness direction of the flange portion includes a recessed portion which is formed by an inner surface of a resin layer of the accommodation portion and a surface of the projecting portion and has a bottom at a connection point between the inner surface of the resin layer of the accommodation portion and the surface of the projecting portion, and
in the sectional shape,
the connection point is a point at which, when a virtual line parallel to an inner surface of the metal layer of the second exterior portion is moved from the inner surface of the metal layer of the second exterior portion to the accommodation space side along a direction orthogonal to the virtual line, the virtual line and the inner surface of the resin layer of the accommodation portion first come into contact with each other, and
at least a part of a surface of the projecting portion forming the recessed portion is on a side opposite to the second exterior portion across the virtual line passing through the connection point.

2. The secondary battery according to claim 1, wherein
in the sectional shape, a thickness of the resin layer of the first exterior portion along a first direction in which a metal layer of the accommodation portion extends from an edge of the accommodation portion is less than a thickness of the resin layer of the second exterior portion other than the joint portion.

3. The secondary battery according to claim 1, wherein
the metal layer of the first exterior portion and the metal layer of the second exterior portion are formed by folding one metal layer.
